(19) United States
(12) Patent Application Publication
(10) Pub. No.: US 2008/0260291 A1
(43) Pub. Date: Oct. 23, 2008

(54) Image downscaling by binning

(75) Inventors: Juha Alakarhu, Tampere (FI); Ossi Kalevo, Toijala (FI); Juha Sarkijarvi, Tampere (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/788,049

(22) Filed: Apr. 17, 2007

(51) Int. Cl. G06T 3/40

(52) U.S. Cl. 382/298

(57) ABSTRACT

The specification and drawings present a new method, apparatus and software product for image binning (downscaling) according to a predetermined procedure for a pre-selected color arrangement (e.g., a Bayer arrangement) by substantially maintaining a phase of channels (represented by selected colors) for reducing/elimination of artifacts in images taken by an electronic device. Several binning or scaling modes where the center points of each binned (e.g., averaged) pixel are arranged in the pre-selected color arrangement and maintain the phase of the channels are described.

### TECHNICAL FIELD

The present invention relates generally to electronic devices comprising image sensors and, more specifically, to binning (downscaling) of images taken by the image sensors.

### BACKGROUND ART

Many image sensors have binning functionality, which means that some downscaling can be done in analog domain before digitizing the signal. The advantage of binning is that it enables such resolution/frame rate combinations that would not otherwise be possible due to ADC (analog-to-digital) or analog readout speed limitation. Furthermore doing scaling in an analog domain provides in some cases higher signal to noise ratio than doing scaling in a digital domain.

The problem with standard analog binning is that after the standard binning, the output video is not similar as, e.g., the raw Bayer output would be. When Bayer interpolation is done to this kind of video stream, the image will have artifact.

Typically, a color video image is represented by channels (or color channels), e.g., a standard Bayer video output has four channels, green_red, red, blue and green_blue, which are uniformly distributed and have equal “distance” to each other (i.e., distances between adjacent pixels in both vertical and horizontal directions). In a standard analog binning, different channels become grouped (e.g., averaged or binned pixels are placed in the middle of the averaging areas, wherein the averaging is performed for each color separately) and the phase difference of the different channels becomes smaller and almost disappears. In other words, distances between adjacent center points of the binned pixels (i.e., after binning is performed) becomes substantially different in both vertical and horizontal directions (see discussion of FIG. 1b). Due to lack of this phase difference, for example if 4×4 binning is done to 5 MP (mega pixels) image, the output resolution appears to be VGA (video graphic array with pixel resolution 640×480), but the actual resolution of the output video is only QVGA (quarter VGA with pixel resolution 320×240). Similarly, if 2×2 binning is done to 5 MP image to have 1.3 MP output mode, HD (high definition) video cannot be implemented because the actual output resolution of the output stream is only VGA.

There are a few earlier methods used to avoid artifacts in the downscaled output image as briefly discussed below:

1. Doing the downscaling after Bayer interpolation. In this case, all pixels have to be digitized and full size image has to be processed, so that large (e.g., 3 to 16 MP) and fast frame rate (e.g., 30 frame per second, fps) for video purposes may not be possible. The power consumption is also very high.

2. Doing the downscaling in digital domain to Bayer data using the methods presented in SMIA Functional specification 1.0, Part 1, Chapter 9 (http://www.smia-forum.org). In this mode, all pixels still need to be digitized so that fast frame rate (30 fps) video purposes may not be possible. However, the power consumption is lower than in case 1.

3. Further downscaling the image by 2×2 after doing Bayer interpolation to a binned image (binned using standard binning). However, in this case, it is difficult to achieve high resolution video mode unless the sensor resolution is very high. To have proper 720 pixel mode, the sensor would need to be 14.7 MP. In addition, the image processing is done slightly differently and it requires special operation mode for the interpolation function, because it has to reduce the image size to a quarter of the original size.

### DISCLOSURE OF THE INVENTION

According to a first aspect of the invention, an apparatus, comprises: an image sensor, configured to capture at least one image comprising a plurality of pixels with a pre-selected color arrangement; and a binning processor, configured to perform binning of the plurality of pixels using a predetermined procedure, wherein center points of binned pixels, representing the at least one image and formed by the binning, maintain the pre-selected color arrangement, distances between any two adjacent center points of the center points are substantially equal in at least one direction, vertical or horizontal, and the binned pixels are for further processing of the at least one image.

According further to the first aspect of the invention, the binning may be performed in an analog domain.

Further according to the first aspect of the invention, all distances between any two adjacent center points of the center points may be substantially equal in both vertical and horizontal directions.

Still further according to the first aspect of the invention, the binning processor may be configured to perform the binning in such a way that each of all or selected pixels of the binned pixels is determined by averaging over a predetermined number of pixels of at least one color located in a predetermined area of the at least one image.

According further to the first aspect of the invention, the pre-selected color arrangement may be a Bayer arrangement. Still further, the binning processor may be configured to perform the binning by averaging pixels of two different green colors in adjacent rows of the Bayer arrangement using weighted values of the two different green colors to form binned green pixels. Yet still further, the binning processor may be configured to perform the binning by averaging pixels of two different green colors in adjacent rows of the Bayer arrangement to form binned green pixels.

According still further to the first aspect of the invention, the binning processor may be configured to perform the binning by including all the pixels.

According further still to the first aspect of the invention, the binning processor may be configured to perform the binning by including only selected pixels of the pixels and by discarding non-selected pixels of the pixels.

According yet further still to the first aspect of the invention, the binning processor may be configured to use at least one of the pixels for determining two or more of the binned pixels formed by the binning.

Yet still further according to the first aspect of the invention, the binning processor may be configured to use overlapping pixel areas selected from the pixels for determining two or more of the binned pixels formed by the binning.

Still yet further according to the first aspect of the invention, the binning processor may be configured to use non-overlapping pixel areas selected from the pixels for determining all or selected pixels of the binned pixels formed by the binning.

Still further still according to the first aspect of the invention, the binning processor may be configured to use a variable number of pixels of the pixels for determining each or selected pixels of the binned pixels formed by the binning.

According further to the first aspect of the invention, the image sensor may be a charged-coupled device or a complimentary metal oxide semiconductor sensor.

Further according to the first aspect of the invention, the apparatus may be a part of an electronic device or of an electronic device for wireless communications.

Still further according to the first aspect of the invention, an integrated circuit may comprise all or selected modules of the apparatus.

According further to the first aspect of the invention, the image sensor and the binning processor may be combined in one module.

According to a second aspect of the invention, an method, comprises: capturing at least one image comprising a plurality of pixels with a pre-selected color arrangement; and binning the plurality of pixels using a predetermined procedure, wherein center points of binned pixels, representing the at least one image and formed by the binning, maintain the pre-selected color arrangement, distances between any two adjacent center points of the center points are substantially equal in at least one direction, vertical or horizontal, and the binned pixels are for further processing of the at least one image.

According further to the second aspect of the invention, all distances between any two adjacent center points of the center points may be substantially equal in both vertical and horizontal directions.

Further according to the second aspect of the invention, each of all or selected pixels of the binned pixels may be determined by averaging over a predetermined number of pixels of at least one color located in a predetermined area of the at least one image using the binning.

Still further according to the second aspect of the invention, the binning may be performed in an analog domain.

According further to the second aspect of the invention, the pre-selected color arrangement may be a Bayer arrangement. Still further, the binning may be performed by averaging pixels of two different green colors in adjacent rows of the Bayer arrangement using weighted values of the two different green colors to form binned green pixels. Yet still further, the binning may be performed by averaging pixels of two different green colors in adjacent rows of the Bayer arrangement to form binned green pixels.

According still further to the second aspect of the invention, the binning may be performed by including all the pixels.

According further still to the second aspect of the invention, the binning may be performed by including only selected pixels of the pixels and by discarding non-selected pixels of the pixels.

According yet further still to the second aspect of the invention, at least one of the pixels may be used for determining two or more of the binned pixels formed by the binning.

Yet still further according to the second aspect of the invention, overlapping pixel areas selected from the pixels may be used for determining two or more of the binned pixels formed by the binning.

Still yet further according to the second aspect of the invention, non-overlapping pixel areas selected from the pixels may be used for determining all or selected pixels of the binned pixels formed by the binning.

Still further still according to the second aspect of the invention, a variable number of pixels of the pixels may be used for determining each or selected pixels of the binned pixels formed by the binning.

According to a third aspect of the invention, a computer program product comprises: a computer readable storage structure embodying computer program code thereon for execution by a computer processor with the computer program code, wherein the computer program code comprises instructions for performing the second aspect of the invention, indicated as being performed by any component or a combination of components of an electronic device.

According to a fourth aspect of the invention, a module, comprises: a binning processor, responsive to an image signal comprising plurality of pixels with a pre-selected color arrangement, configured to perform binning of the plurality of pixels using a predetermined procedure, wherein center points of binned pixels, representing the at least one image and formed by the binning, maintain the pre-selected color arrangement, distances between any two adjacent center points of the center points are substantially equal in at least one direction, vertical or horizontal, and the binned pixels are for further processing of the at least one image.

According further to the fourth aspect of the invention, the module may further comprise: a processing memory configured to store temporarily values of the plurality pixels of the at least one image during performing the binning.

Further according to the fourth aspect of the invention, the binning processor may be configured to use at least one of the pixels for determining two or more of the binned pixels formed by the binning.

### BRIEF DESCRIPTION OF THE DRAWINGS

For a better understanding of the nature and objects of the present invention, reference is made to the following detailed description taken in conjunction with the following drawings, in which:

FIGS. 1a and 1b are schematic representations of a raw Bayer arrangement (FIG. 1a) and a standard 2×2 binning of the raw Bayer arrangement (FIG. 1b);

FIG. 2 is a schematic representation of downscaled pixels of a raw Bayer arrangement using 2×2 binning without pixel overlapping and with Gr/Gb correction, according to an embodiment of the present invention;

FIG. 3 is a schematic representation of downscaled pixels of a raw Bayer arrangement using 3×3 binning without pixel overlapping, according to an embodiment of the present invention;

FIG. 4 is a schematic representation of downscaled pixels of a raw Bayer arrangement using 1×3 binning without pixel overlapping, according to an embodiment of the present invention;

FIG. 5 is a schematic representation of downscaled pixels of a raw Bayer arrangement using 4×4 binning without pixel overlapping and with Gr/Gb correction, according to an embodiment of the present invention;

FIGS. 6a and 6b are schematic representations of downscaled pixels of raw Bayer arrangements using 3×3 binning with pixel overlapping without (FIG. 6a) or with (FIG. 6b) Gr/Gb correction, according to embodiments of the present invention;

FIGS. 7a and 7b are exemplary block diagrams of an electronic device for implementing image binning (downscaling), according to embodiments of the present invention; and

FIG. 8 is a flow chart for implementing image binning (downscaling), according to an embodiment of the present invention.

### MODES FOR CARRYING OUT THE INVENTION

A new method, apparatus and software product for image binning (downscaling) according to a predetermined procedure for a pre-selected color arrangement (e.g., a Bayer arrangement) by substantially maintaining a phase of channels (represented by selected colors) for reducing/elimination of artifacts in images taken by an electronic device (apparatus). Embodiments of the present invention describe several binning or scaling modes where the center points of each binned (e.g., averaged) pixel are arranged in the pre-selected color arrangement.

After capturing an image comprising a plurality of pixels with the pre-selected color arrangement, binning said plurality of pixels (e.g., averaged or binned pixels are placed in the middle of the averaging areas, wherein the averaging is performed for each color separately) using a predetermined procedure is performed in such a way that center points of the binned pixels, representing the captured image and formed by said binning, maintain the pre-selected color arrangement and distances between any two adjacent center points of said center points are substantially equal in at least one direction, vertical or horizontal, or in both vertical and horizontal directions, thus maintaining the phase of the channels substantially equal. These binned (e.g., averaged) pixels can be used for further processing of said at least one image (e.g., for interpolation in a digital domain). This way, the phases of the channels representing by pre-selected colors are kept and standard processing (e.g., Bayer interpolation) can be applied using the further image processing.

According to one embodiment, each of all or selected pixels of the binned pixels can be determined by averaging over a predetermined number of pixels of at least one color located in a predetermined area of the image using said binning.

According to further embodiments of the present invention there are many binning models which can be used which include but are not limited to:

perform binning by including all the pixels of the raw color image;

perform binning by including only selected pixels and by discarding non-selected pixels;

perform binning in such a way that at least one of the pixels is used for determining two or more of the binned (e.g., averaged) pixels formed by the binning (some small processing memory is required);

perform binning in such a way that overlapping pixel areas are used for determining two or more of the binned (e.g., averaged) pixels formed by the binning;

perform binning in such a way that non-overlapping pixel areas are used for determining all or selected pixels of the binned (e.g., averaged) pixels formed by the binning;

perform binning in such a way that pixels are weighted with different weights of the binned (e.g., averaged) pixels formed by the binning;

perform binning in such a way that a variable number of pixels is used for determining each or selected pixels of the binned (e.g., averaged) pixels formed by the binning, etc.

The electronic device used for the binning described herein can be, but is not limited to, a camera, a digital camera, a wireless communication device, a mobile phone, a camera-phone mobile device, a portable electronic device, non-portable electronic device, etc., utilizing an image sensor (e.g., charged-coupled device, CCD or a complimentary metal oxide semiconductor sensor, CMOS) for capturing the image.

It is further noted that the image binning, described herein, is typically performed in an analog domain, e.g., by combining charges directly in the pixels or using capacitor for analog summing. However, the embodiments of the present invention describing said binning can be also implemented or partially implemented using digital scaling prior to standard digital processing/interpolation.

The embodiments of the present invention presented herein can enables better video quality, can make possible tradeoffs between sharpness and noise, and can be especially useful when implementing high-definition (HD) video modes.

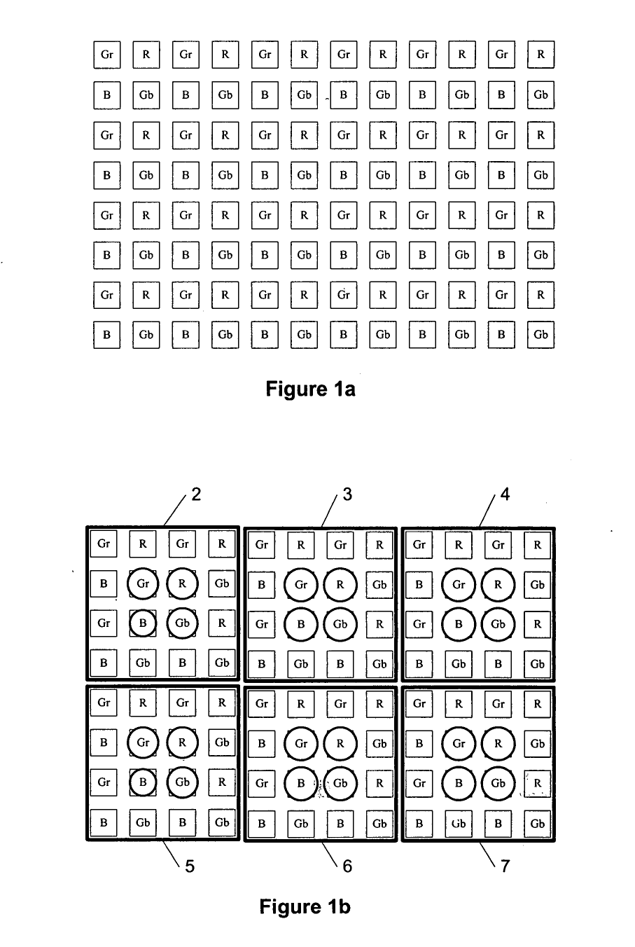

FIGS. 1a and 1b show examples of schematic representations of a raw Bayer arrangement shown in FIG. 1 a with four channels, green_red (Gr), red (R), blue (B) and green_blue (Gb), which are uniformly distributed and have equal “distance” to each other (i.e., between adjacent pixels in both vertical and horizontal directions), and a standard 2×2 binning of the raw Bayer arrangement shown in FIG. 1b. In FIG. 1b, different channels are grouped within 4×4 pixel areas 2, 3 . . . 7 using 4 pixels of the same color for averaging (the averaging is performed for each color separately), as shown in FIG. 1b, and the averaged or binned pixels are placed in the middle of the area comprising 4 averaged pixels for each color, such that the phase difference of the different channels becomes smaller and almost disappears which can cause artifacts. In other words, distances between adjacent center points of the binned pixels (circled pixels) becomes substantially different in both vertical and horizontal directions as seen in FIG. 1b.

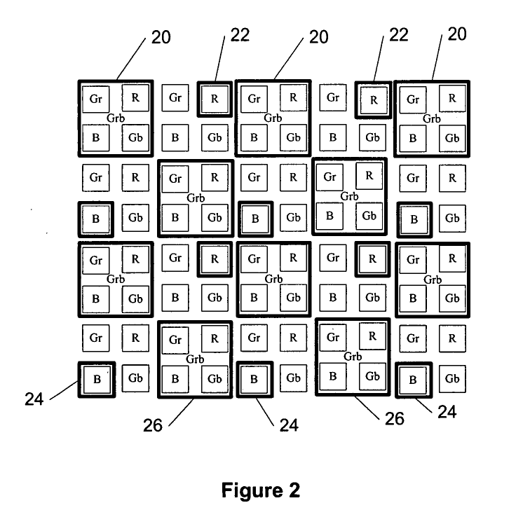

FIGS. 2-6 represent several selected examples demonstrating various embodiments of the present invention.

FIG. 2 shows an example among others of a schematic representation of downscaled pixels of a raw Bayer arrangement using 2×2 binning without pixel overlapping and with Gr/Gb correction, according to an embodiment of the present invention. In this arrangement, 2×2 pixel areas 20 are used for averaging Gr and Gb pixels and forming averaged pixels Grb in the middle of pixel areas 20, thus providing the Gr/Gb correction. In the pixel areas 20 Gr and Gb pixels are used for averaging and B and R pixels are discarded. Red and blue pixels 22 and 24 are selected as binning pixels and other un-highlighted pixels are discarded.

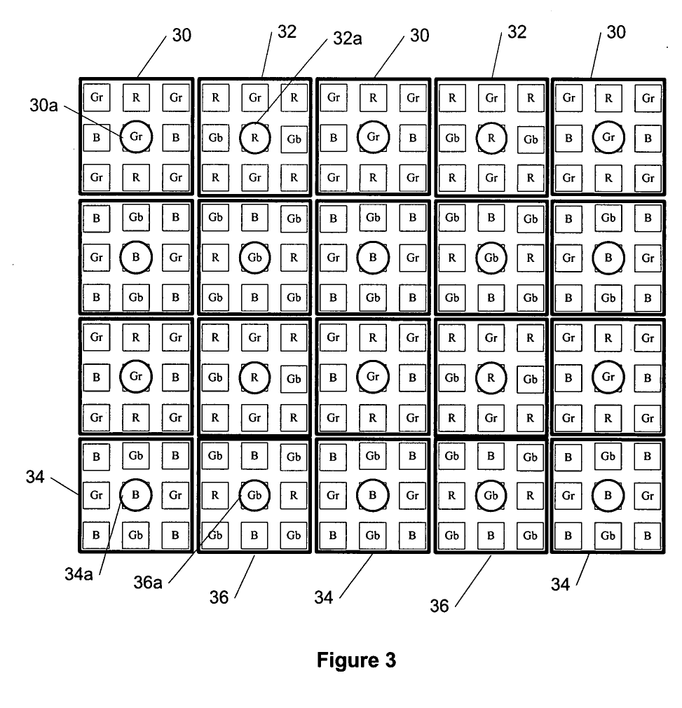

FIG. 3 shows an example among others of a schematic representation of downscaled pixels of a raw Bayer arrangement using 3×3 binning without pixel overlapping, according to an embodiment of the present invention. In this arrangement, 3×3 pixel areas 30 are used for averaging 4 Gr pixels comprised in the areas 30 and forming averaged Gr pixels 30a in the middle of the pixel areas 30, (discarding the rest of the pixels of the pixel areas 30). Similarly, 3×3 pixel areas 32 are used for averaging 4 R pixels comprised in the areas 32 and forming averaged R pixels 32a in the middle of the pixel areas 32, (discarding the rest of the pixels of the pixel areas 32). Moreover, 3×3 pixel areas 34 are used for averaging 4 B pixels comprised in the areas 34 and forming averaged B pixels 34a in the middle of the pixel areas 34, (discarding the rest of the pixels of the pixel areas 34). Finally, 3×3 pixel areas 36 are used for averaging 4 Gb pixels comprised in the areas 36 and forming averaged Gb pixels 36a in the middle of the pixel areas 36, (discarding the rest of the pixels of the pixel areas 36).

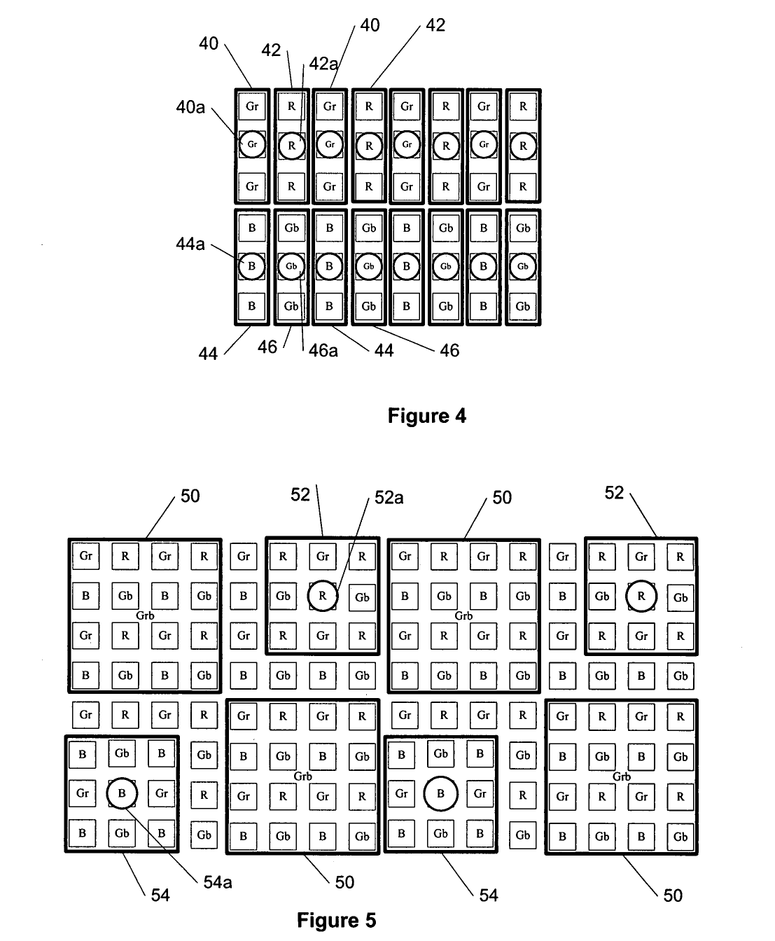

FIG. 4 shows an example among others of a schematic representation of downscaled pixels of a raw Bayer arrangement using 1×3 binning without pixel overlapping, according to an embodiment of the present invention. In this arrangement, 1×3 pixel areas 40 are used for averaging 2 Gr pixels and forming averaged Gr pixels 40a in the middle of the pixel areas 40. Similarly, 1×3 pixel areas 42 are used for averaging 2 R pixels and forming averaged R pixels 42a in the middle of the pixel areas 42. Moreover, 1×3 pixel areas 44 are used for averaging 2 B pixels and forming averaged B pixels 44a in the middle of the pixel areas 44. Furthermore, 1×3 pixel areas 46 are used for averaging 2 Gb pixels and forming averaged Gb pixels 46a in the middle of the pixel areas 46. It is noted that the binning in FIG. 4 is performed only for one vertical dimension because in the horizontal direction the spacing between binned (averaged) pixels stays the same as in the original raw Bayer pattern. Similarly, the binning can be performed only in the horizontal direction, e.g., using 3×1 pixel areas for averaging and forming averaged (binned) pixels.

FIG. 5 shows an example among others of a schematic representation of downscaled pixels of a raw Bayer arrangement using 4×4 binning without pixel overlapping and with Gr/Gb correction, according to an embodiment of the present invention. In this arrangement, 4×4 pixel areas 50 are used for averaging Gr and Gb pixels comprised in the areas 50 and forming averaged pixels Grb in the middle of the pixel areas 50, thus providing the Gr/Gb correction. In the pixel areas 50, Gr and Gb pixels are used for averaging and B and R pixels are discarded. Moreover, 3×3 pixel areas 52 are used for averaging 4 R pixels comprised in the areas 52 and forming averaged R pixels 52a in the middle of the pixel areas 52, (discarding the rest of the pixels of the pixel area 50). Similarly, 3×3 pixel areas 54 are used for averaging 4 B pixels comprised in the areas 54 and forming averaged B pixels 54a in the middle of the pixel areas 54, (discarding the rest of the pixels of the pixel area 54). It is further noted that un-highlighted pixels in FIG. 5 are discarded.

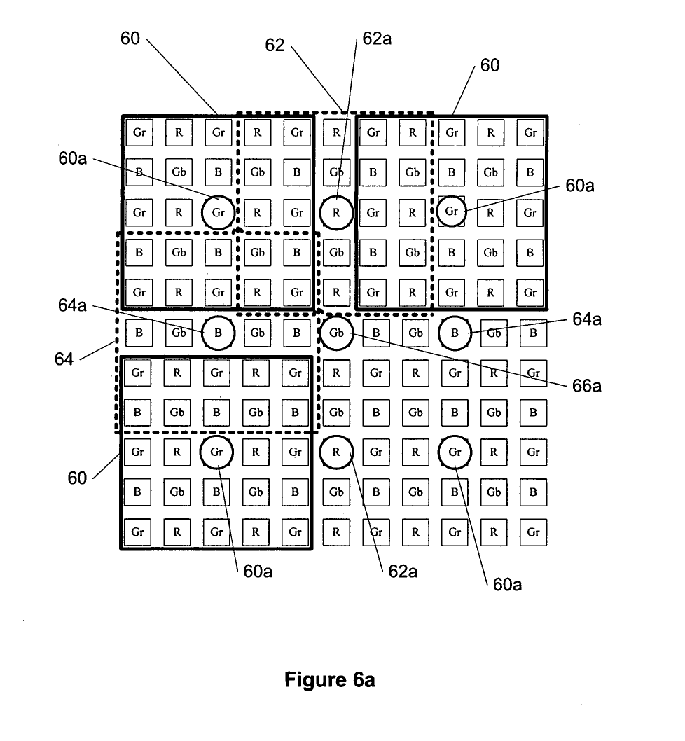

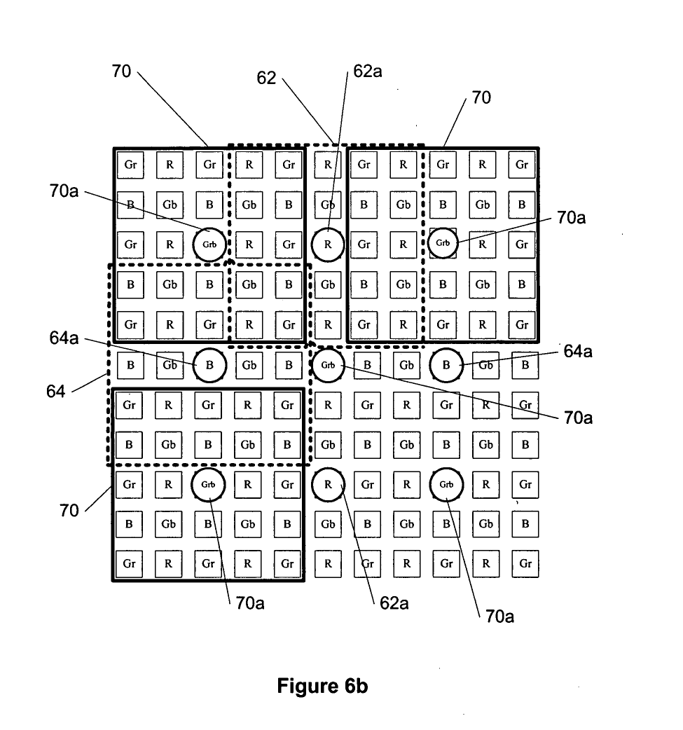

FIGS. 6a and 6b shows examples among others of schematic representations of downscaled pixels of raw Bayer arrangements using 3×3 binning with pixel overlapping without (as shown in FIG. 6a) or with (as shown in FIG. 6b) Gr/Gb correction, according to embodiments of the present invention.

In the arrangement of FIG. 6a, 5×5 pixel areas 60 are used for averaging Gr pixels comprised in the areas 60 and forming averaged pixels Gr 60a in the middle of the pixel areas 60. Moreover, 5×5 pixel areas 62, overlapping with the pixel areas 60 as shown in FIG. 6a, are used for averaging R pixels comprised in the areas 62 and forming averaged pixels R 62a in the middle of pixel areas 62. Furthermore, 5×5 pixel areas 64, overlapping with the pixel areas 60 and 62 as shown in FIG. 6a, are used for averaging B pixels 64a comprised in the areas 64 and forming averaged pixels B in the middle of pixel areas 64. Similarly, 5×5 pixel areas (e.g., an area around the pixels 66a in the center) overlapping with the pixel areas 60, 62 and 64 are used for averaging Gb pixels comprised in these 5×5 pixel areas around the pixel 66a and forming the averaged pixels Gb 66a. Thus all pixels of the original raw Bayer image are used for the binning (scaling) procedure.

In the arrangement shown in FIG. 6b, the difference with the arrangement shown in FIG. 6a is that the areas 60 and the 5×5 pixel areas around the pixel 66a become identical in FIG. 6b from the point of the averaging method and are shown as 5×5 pixel areas 70 in FIG. 6b, wherein 5×5 pixel areas 70 are used for averaging Gr and Gb pixels and forming averaged pixels Grb in the middle of pixel areas 70, thus providing a Gr/Gb correction. It is noted that each of the pixels Gr and Gb are used twice in the algorithm presented in FIG. 6b, therefore some small processing memory may be required for implementing this algorithm.

It is further noted that averaging in the 5×5 pixel areas 70 without using weighted pixel values for Gr and Gb can only provide a partial Gr/Gb correction because there are 9 Gr but only 4 Gb pixels in each of the 5×5 pixel areas 70. To perform a full Gr/Gb correction, the Gr and Gb pixel values in each of the areas 70 can be weighted with a relative coefficient 4/9 in order to provide an equal weight for averaging the Gr and Gb pixels comprised in the areas 70. Moreover, according to another embodiment, each of the areas 70 shown in FIG. 6b can be expanded by 1 row and one column to become 6×6 pixel areas having equal number of Gr and Gb pixels thus providing a full Gr/Gb correction without using weighted pixel values. In this case the position of combined Grb value is also slightly changed to be in the middle of the modified 6×6 area 70.

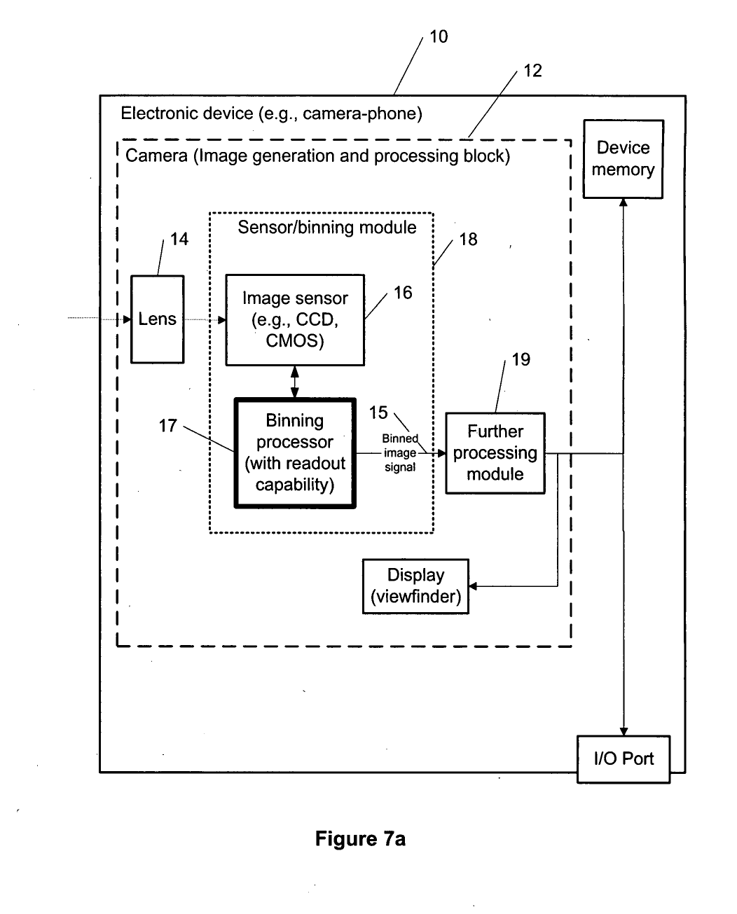

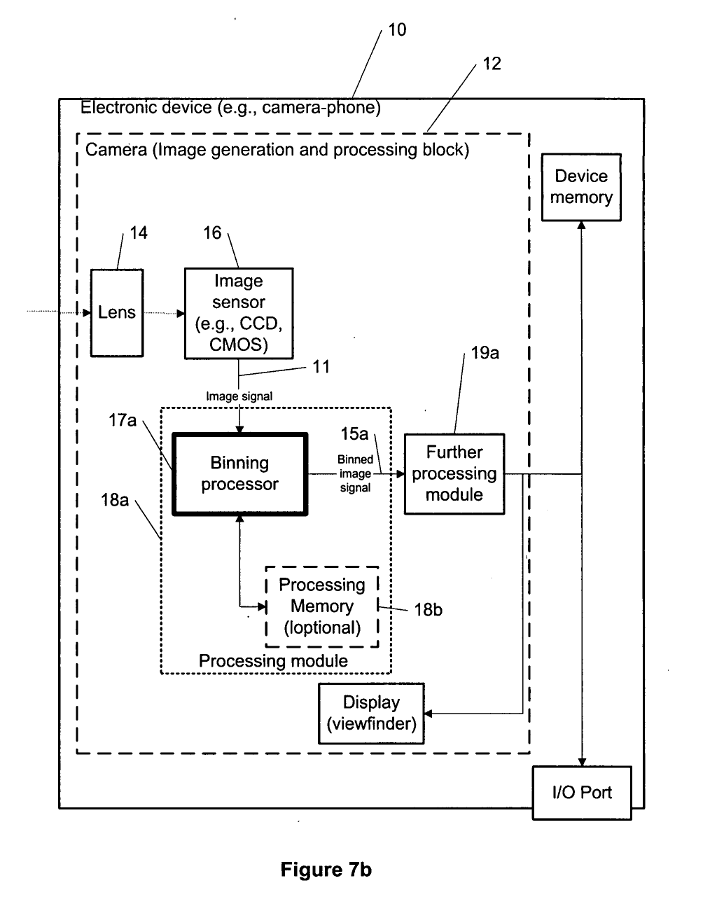

FIGS. 7a and 7b show exemplary block diagrams of an electronic device 10 comprising a camera 12 for implementing image binning (downscaling), according to embodiments of the present invention. The electronic device 10 can be, but is not limited to, a camera, a digital camera, a wireless communication device, a mobile phone, a camera-phone mobile device, a portable electronic device, non-portable electronic device, etc.

In FIG. 7a, the camera 12 can comprise a lens 14 and an image sensor 16 (for example using a CCD or a CMOS sensor) for capturing a color image using, e.g., a Bayer arrangement. A binning processor 17 optionally with a readout capability (the module 17 could be a binning/readout module) can implement analog binning of the image (e.g., by combining charges directly in the pixels or using capacitor for analog summing) according to the embodiments of the present invention described herein. The module 17 can be typically implemented as hardware, but also as a combination of software and hardware. Furthermore, the module 17 can be implemented as a separate block or can be combined with any other block or module of the electronic device 10 or it can be split into several blocks according to their functionality. In the example of FIG. 7a, the binning processor 17 is combined with the image sensor 16 in one module sensor/binning module which can be implemented, e.g., as an integrated circuit.

The binned image signal 15 generated by the module 17, can be provided to a further processing module 19 (e.g., for digital signal processing) and then can be further provided (optionally) as an output to different modules of the electronic device 10, e.g., to a display (viewfinder) for viewing, to a device memory for storing, or to an input/output (I/O) port for forwarding to a desired destination.

In another embodiment shown in FIG. 7b the binning processor 17a can be a part of the processing module 18a separately from the image sensor 16. This implies that the image signal generated by the image sensor 16 is provided to the binning processor 17a for performing the binning (typically using analog domain but possibly digital scaling as well, as described herein). A small processing memory can be also a part of the processing module 18a for implementing a binning mode wherein the same original pixel can be used multiple times (two or more) for calculating average binned pixels, for example according to algorithm exemplified in FIG. 6b. The binned image signal 15a generated by the module 17a, can be provided to a further processing module 19a (e.g., for digital signal processing) and then can be further provided (optionally) as an output to different modules of the electronic device 10, as in FIG. 7a.

It is further noted that the image sensor 16 and the processing module 18a shown in FIG. 7b can be parts of different devices and the image signal 11 can be provided by a first device comprising the image sensor 16 to a second device comprising the processing module 18a. Moreover, the binning described herein can happen in two phases. For example, the binning in one direction (e.g., horizontal), can be performed in analog domain by the sensor/binning module 18 shown in FIG. 7a, and the binning in another direction (e.g., vertical) can be performed possibly in a digital domain by the processing module 18a shown in FIG. 7b, using various embodiments of the present invention.

It is also noted that the binning processor 17 or 17a can generally be means for binning or a structural equivalence (or an equivalent structure) thereof. Similarly, the image sensor 16 can generally be means for capturing an image or a structural equivalence (or equivalent structure) thereof. Also all or selected blocks and modules of the electronic device 10 can be implemented using an integrated circuit.

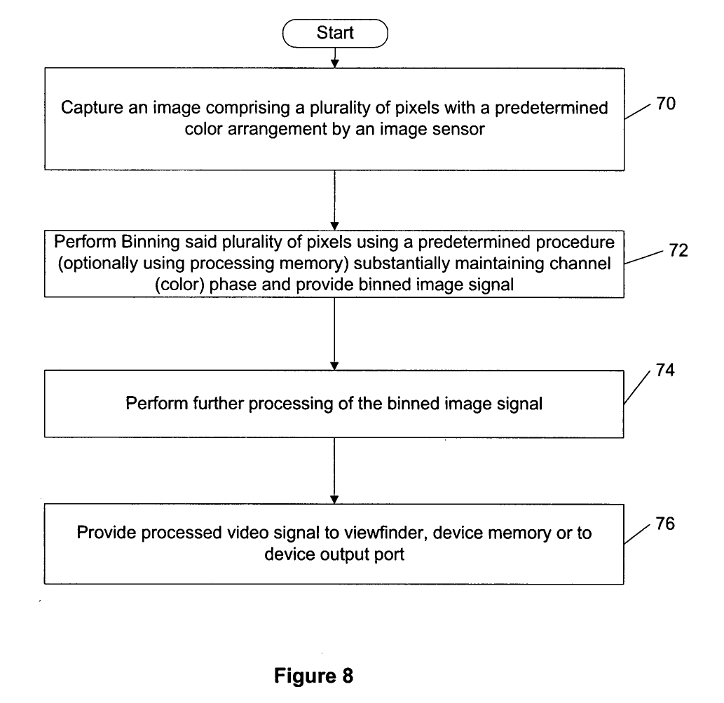

FIG. 8 shows an example of a flow chart for implementing image binning (downscaling), according to an embodiment of the present invention.

The flow chart of FIG. 8 only represents one possible scenario among others. It is noted that the order of steps shown in FIG. 8 is not absolutely required, so in principle, the various steps can be performed out of order. In a method according to the embodiment of the present invention, in a first step 70, the image comprising a plurality of pixels with a predetermined color arrangement is captured by the image sensor. In a next step 72, binning of said plurality of pixels is performed using a predetermined procedure (optionally using processing memory) substantially maintaining channel (color) phase for providing a binned image signal, i.e., the predetermined procedure is performed in such a way that center points of the binned pixels, representing the captured image and formed by the binning, maintain the pre-selected color arrangement, and distances between any two adjacent center points of said center points are substantially equal in at least one direction, vertical or horizontal, or in both vertical and horizontal directions, thus maintaining the phase of the channels as close as possible.

In a next step 74, this binned image signal (e.g., an analog signal) is further processed using digital signal processing and in a next step 76, a processed video signal is provided to a viewfinder, a device memory or to a device output port, etc.

As explained above, the invention provides both a method and corresponding equipment consisting of various modules providing the functionality for performing the steps of the method. The modules may be implemented as hardware, or may be implemented as software or firmware for execution by a computer processor. In particular, in the case of firmware or software, the invention can be provided as a computer program product including a computer readable storage structure embodying computer program code (i.e., the software or firmware) thereon for execution by the computer processor.

It is noted that various embodiments of the present invention recited herein can be used separately, combined or selectively combined for specific applications.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

1. An apparatus, comprising:
a binning processor, configured to perform binning of a plurality of pixels with a pre-selected color arrangement comprised in an image using a predetermined procedure, wherein
center points of binned pixels, representing said image and formed by said binning, maintain said pre-selected color arrangement,
distances between any two adjacent center points of said center points are substantially equal in at least one direction, vertical or horizontal, and
said binned pixels are for further

2. The apparatus of claim 1, wherein said binning is performed in an analog domain.

3. The apparatus of claim 1, wherein all distances between any two adjacent center points of said center points are substantially equal in both vertical and horizontal directions.

4. The apparatus of claim 1, wherein the binning processor is configured to perform said binning in such a way that each of all or selected pixels of said binned pixels is determined by averaging over a predetermined number of pixels of at least one color located in a predetermined area of said image.

5. The apparatus of claim 1, wherein said pre-selected color arrangement is a Bayer arrangement.

6. The apparatus of claim 5, wherein said binning processor is configured to perform said binning by averaging pixels of two different green colors in adjacent rows of said Bayer arrangement using weighted values of said two different green colors to form binned green pixels.

7. The apparatus of claim 5, wherein said binning processor is configured to perform said binning by averaging pixels of two different green colors in adjacent rows of said Bayer arrangement to form binned green pixels.

8. The apparatus of claim 1, wherein said binning processor is configured to perform said binning by including all said pixels.

9. The apparatus of claim 1, wherein said binning processor is configured to perform said binning by including only selected pixels of said pixels and by discarding non-selected pixels of said pixels.

10. The apparatus of claim 1, wherein said binning processor is configured to use at least one of said pixels for determining two or more of said binned pixels formed by said binning.

11. The apparatus of claim 1, wherein said binning processor is configured to use overlapping pixel areas selected from said pixels for determining two or more of said binned pixels formed by said binning.

12. The apparatus of claim 1, wherein said binning processor is configured to use non-overlapping pixel areas selected from said pixels for determining all or selected pixels of said binned pixels formed by said binning.

13. The apparatus of claim 1, wherein said binning processor is configured to use a variable number of pixels of said pixels for determining each or selected pixels of said binned pixels formed by said binning.

14. The apparatus of claim 35, wherein said image sensor is a charged-coupled device or a complimentary metal oxide semiconductor sensor.

15. The apparatus of claim 1, wherein said apparatus is a part of an electronic device or of an electronic device for wireless communications.

16. The apparatus of claim 1, wherein an integrated circuit comprises all or selected modules of said apparatus.

17. The apparatus of claim 35, wherein said image sensor and the binning processor are combined in one module.

18. A method, comprising:
binning a plurality of pixels with a pre-selected color arrangement comprised in an image using a predetermined procedure, wherein
center points of binned pixels, representing said image and formed by said binning, maintain said pre-selected color arrangement,
distances between any two adjacent center points of said center points are substantially equal in at least one direction, vertical or horizontal, and
said binned pixels are for further processing of said image.

19. The method of claim 18, wherein all distances between any two adjacent center points of said center points are substantially equal in both vertical and horizontal directions.

20. The method of claim 18, where each of all or selected pixels of said binned pixels is determined by averaging over a predetermined number of pixels of at least one color located in a predetermined area of said image using said binning.

21. The method of claim 18, wherein said binning is performed in an analog domain.

22. The method of claim 18, wherein said pre-selected color arrangement is a Bayer arrangement.

23. The apparatus of claim 22, wherein said binning is performed by averaging pixels of two different green colors in adjacent rows of said Bayer arrangement using weighted values of said two different green colors to form binned green pixels.

24. The method of claim 22, wherein said binning is performed by averaging pixels of two different green colors in adjacent rows of said Bayer arrangement to form binned green pixels.

25. The method of claim 18, wherein said binning is performed by including all said pixels.

26. The method of claim 18, wherein said binning is performed by including only selected pixels of said pixels and by discarding non-selected pixels of said pixels.

27. The method of claim 18, wherein at least one of said pixels is used for determining two or more of said binned pixels formed by said binning.

28. The method of claim 18, wherein overlapping pixel areas selected from said pixels are used for determining two or more of said binned pixels formed by said binning.

29. The method of claim 18, wherein non-overlapping pixel areas selected from said pixels are used for determining all or selected pixels of said binned pixels formed by said binning.

30. The method of claim 18, wherein a variable number of pixels of said pixels are used for determining each or selected pixels of said binned pixels formed by said binning.

31. A computer program product comprising:
a computer readable storage structure embodying computer program code thereon for execution by a computer processor with said computer program code, wherein said computer program code comprises instructions for performing the method of claim 18.

32. A module, comprising:
a binning processor, configured to response to an image signal comprising information on a plurality of pixels with a pre-selected color arrangement comprised in an image, configured to perform binning of said plurality of pixels using a predetermined procedure, wherein
center points of binned pixels, representing said image and formed by said binning, maintain said pre-selected color arrangement,
distances between any two adjacent center points of said center points are substantially equal in at least one direction, vertical or horizontal, and
said binned pixels are for further processing of said image.

33. The module of claim 32, further comprising:
a processing memory, configured to store temporarily values of said plurality pixels of said at least one image during performing said binning.

34. (canceled)

35. The apparatus of claim 1, further comprising an image sensor configured to capture said image comprising the plurality of pixels with the pre-selected color arrangement.
